(19) United States
(12) Patent Application Publication
(10) Pub. No.: US 2012/0330878 A1
(43) Pub. Date: Dec. 27, 2012

(54) CONVENTIONS FOR INFERRING DATA MODELS

(75) Inventors: Arthur VICKERS, Redmond, WA (US); Diego Vega, Sammamish, WA (US); Rowan Miller, Kirkland, WA (US); Andrew Peters, Sammamish, WA (US); Jeff Derstadt, Sammamish, WA (US)

(73) Assignee: Microsoft Corporation, Redmond, WA (US)

(21) Appl. No.: 13/166,825

(22) Filed: Jun. 23, 2011

(51) Int. Cl. G06N 5/02

(52) U.S. Cl. 706/50

(57) ABSTRACT

A programming environment may use a set of conventions that may infer database objects from memory objects or memory objects from database objects. The inferred objects may be referenced and used in the programming environment after being created by the set of conventions. The set of conventions may be added to or modified to create different results that are inferred by the conventions. Some conventions may be dependent on other conventions, and the dependencies may be modified by reordering the conventions or otherwise redefining the dependencies. In some embodiments, a versioning system may manage different versions of the convention sets for various upgrade scenarios.

### BACKGROUND

Many computer applications use a combination of databases and data types to store and manipulate data. In many database driven applications, a relational database may be created to store various information, and calls may be made to the database to store and retrieve data. Similarly, the same applications may store and manipulate data in memory objects, which may contain data retrieved from the database.

In many computer programming systems, such applications may be created by separately creating the databases and memory objects. Such effort may be duplicative in some cases and may be tedious and error prone.

### SUMMARY

A programming environment may use a set of conventions that may infer database objects from memory objects or memory objects from database objects. The inferred objects may be referenced and used in the programming environment after being created by the set of conventions. The set of conventions may be added to or modified to create different results that are inferred by the conventions. Some conventions may be dependent on other conventions, and the dependencies may be modified by reordering the conventions or otherwise redefining the dependencies. In some embodiments, a versioning system may manage different versions of the convention sets for various upgrade scenarios.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram of an embodiment showing a system for using conventions in code development.

FIG. 2 is a diagram of an embodiment showing a sequence for using conventions in code development.

FIG. 3 is a flowchart of an embodiment showing a method for using conventions in code development.

### DETAILED DESCRIPTION

A programming environment may infer database objects from memory objects and memory objects from database objects. The inferences may allow a programmer to define objects in one form and use the objects in another form.

The inferences may be made from a set of conventions that interpret the various objects to create a corresponding object. The set of conventions may be expanded and modified to address different naming conventions, data type interpretations, or other situations.

The conventions may be applied in a sequential manner, where the sequence defines a hierarchy or precedence for the various conventions. By changing the sequence of the individual conventions, the conventions may result in different inferences being made. The conventions may be managed through an application programming interface (API) that may add or remove conventions to the sequence.

The conventions may produce an entity data model or object-relational mapping of the various objects in a set of code.

In one use scenario, a developer may write code in a familiar language that defines several memory objects. The conventions may be applied to generate corresponding data objects in a database that may then be accessed using database queries. The conventions may ensure that the memory objects and database share the same schema and may be accessed using either the memory objects or database queries. Such a system may speed up program development and at the same time allow a developer to query either memory objects or the database as convenient.

The conventions may be managed using a versioning system that may apply groups of conventions as defined in different versions. In some cases, a developer may select from a group of conventions to be applied in a specific application. The conventions may be updated, modified, changed, and improved over time while allowing the developer to continue to use an earlier set of conventions in existence when an application was developed.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

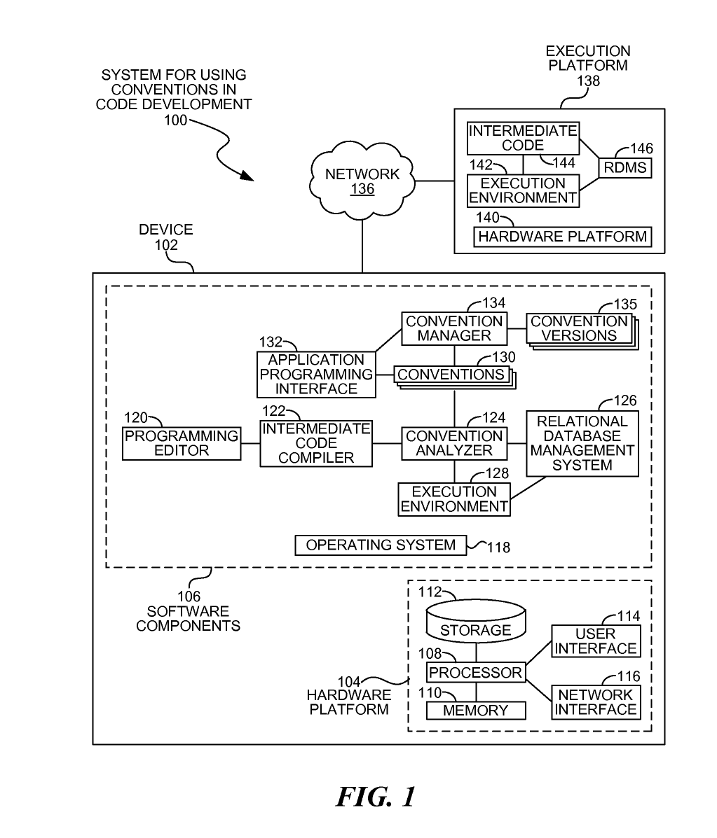

FIG. 1 is a diagram of an embodiment 100, showing a device 102 that may be used to create executable application code that includes database information derived from application code.

The diagram of FIG. 1 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the described functions.

Embodiment 100 illustrates an environment in which database objects may be inferred or derived from application code using a set of conventions. The conventions may define rules by which memory objects defined in application source code may be used to create a database, which may be used as part of the application. The conventions may create an entity data model that may be an object-relational mapping between memory objects with complex data types and database objects with scalar data types. In many cases, the entity data model may include relationships, constraints, or other metadata.

The conventions may be a set of rules that interprets memory objects and infers a database structure based on the memory objects. The conventions may infer structure based on naming conventions or other identifiers for the memory objects.

The conventions may be modified by a programmer and configured into a set of conventions that apply to certain applications. In some embodiments, the conventions may be managed using a versioning system that may maintain various sets of conventions that are used with certain applications, while allowing additional conventions to be incorporated into future applications.

In a simple example, a set of memory objects may be defined using “ID” or “Key” names. These objects may be identified by the conventions as indexes or keys for a database, and may be further inferred to be primary keys or foreign keys, depending on the context. The conventions may create the corresponding keys in a database and establish a corresponding object relational model element.

The conventions may be executed on source code or intermediate code. Source code may refer to code written by a developer, while intermediate code may be source code that has been compiled. Intermediate code may be further compiled at runtime into machine code that is executable. Intermediate code may include mappings or other metadata that relate back to names used in the source code.

When conventions are executed against intermediate code, the conventions may use various syntactic or semantic information. The additional information may be embedded in the intermediate code or contained in a separate location or file.

In some embodiments, the conventions may create a new database based on classes or other memory objects defined in source code. Such embodiments may infer database tables from the memory objects and create those tables. The database may be accessed through the source code or through another application that performs queries against the database.

In some embodiments, the conventions may evaluate an existing database and create a mapping from the existing database schema to memory objects defined in the source code. In some embodiments, the first time an application may be compiled may generate a new database and subsequent modifications and compilations may update the mapping.

The system of embodiment 100 is illustrated as being contained in a single device 102. The device 102 may have a hardware platform 104 and software components 106. The device 102 may represent a developer's workstation where the developer may create, compile, test, and edit code on a single device. Other embodiments may deploy one or more components on different hardware platforms.

The device 102 may represent a user workstation or other powerful, dedicated computer system that may be used to develop and test code. In some embodiments, however, the device 102 may be any type of computing device, such as a personal computer, game console, cellular telephone, netbook computer, or other computing device.

The hardware platform 104 may include a processor 108, random access memory 110, and nonvolatile storage 112. The processor 108 may be a single microprocessor, multi-core processor, or a group of processors. The random access memory 110 may store executable code as well as data that may be immediately accessible to the processor 108, while the nonvolatile storage 112 may store executable code and data in a persistent state.

The hardware platform 104 may include a user interface 114. The user interface 114 may include monitors, keyboards, pointing devices, and other input and output devices for a user. The user input devices may include keyboards, pointing devices such as mice or styli, audio and video input or output devices, or other peripherals. In some embodiments, the user input devices may include ports through which a user may attach various peripheral devices. Examples of such ports may be Firewire, Universal Serial Bus (USB), or other hardwired connections. Other examples may include wireless ports such as Bluetooth, WiFi, or other connection types.

The hardware platform 104 may also include a network interface 116. The network interface 116 may include hardwired and wireless interfaces through which the device 102 may communicate with other devices.

The software components 106 may include an operating system 118 on which various applications may execute.

A programming editor 120 may be an application in which a developer may write source code. Many programming editors may include compilers, debugging systems, and other tools that help a developer write and test code.

After generating source code with the programming editor 120, an intermediate code compiler 122 may generate intermediate code.

A convention analyzer 124 may analyze the intermediate code to identify database objects that can be inferred from the code. The convention analyzer 124 may create a database in a relational database management system 126. In some cases, the convention analyzer 124 may use an existing database to modify the database or to create a mapping between the memory objects in the intermediate code and the schema of the database.

The system may include an execution environment 128 in which the compiled code may be executed. In some cases, the execution environment 128 may be a debugging environment that may be instrumented to monitor various items during execution. In other cases, the execution environment 128 may be a production execution environment in which the code may be executed in a production mode, as opposed to a debug mode.

The convention analyzer 124 may operate with a set of conventions 130 that may be modified and organized using an application programming interface 132 and a convention manager 134. The application programming interface 132 may be an interface through which a developer may add or modify conventions, set the order or priority of conventions, or organize the conventions into sets that may be applied to the code.

A convention manager 134 may manage which conventions are applied to a specific application. For a specific application, a developer may select certain conventions to be applied. In many cases, a developer may create one or more conventions that define certain inferences based on the developer's personal programming style or specific inferences based on the precise application.

The convention manager 134 may allow the developer to select a specific set of conventions and arrange the conventions in a hierarchy or precedence to coincide with the developer's application and preferences. In a simple example, one developer may use the notation “Id” as a primary key for a certain type of data, while another developer may prefer the notation “Key”. Each developer may use their favorite convention to identify database keys from the memory objects by editing a preexisting convention or creating their own.

When the developer identifies and arranges the conventions for a specific application, that set of conventions may be stored as one of the convention versions 135. The convention versions 135 may contain sets of conventions that may be applied to specific applications. In many embodiments, the conventions may be improved, expanded, and modified over time into newer versions. The convention manager 134 may permit a version of the sets of conventions to remain stable so that later changes to the source code of an application may be processed with the same version of conventions as was originally used to create the application. Such a system may minimize the chance that a new version of conventions may cause an application to break when compiled and executed.

The convention manager 134 may also act as a registration system. A registration system may accept conventions and register those conventions as usable for analysis. A developer may check in new conventions and check out existing conventions for updating and changes. In some cases, the registration system may permit a developer to replace one convention with another or perform other convention management tasks.

In some embodiments, the device 102 may be used for code development while other devices may be used for executing the finished code. Such embodiments may be execution platforms 138 that may be accessed over a network 136. In some embodiments, the execution platforms 138 may have the executable code and databases transmitted via some software medium, such as an optical or magnetic disk, solid state memory device, or other storage medium.

The execution platform 138 may contain many of the same items as the device 102, but may not contain development level components that may be used for writing, testing, and debugging code. The execution platform 138 may have a hardware platform 140 that may be similar to the hardware platform 104 containing a processor and other components.

The hardware platform 140 may be any type of computing platform. The hardware platform 140 may be a server computer, desktop computer, laptop computer, game console, mobile telephone, portable personal digital computer, media player, or any other device with a processor.

The execution platform 138 may include an execution environment 142 that executes intermediate code 144 and execute with a relational database management system 146. In some embodiments, the execution environment 142 may execute machine code and not intermediate code.

In some embodiments, the relational database management system 146 may be a service accessed over the network 136 and provided by another device, which could be a cloud based database system.

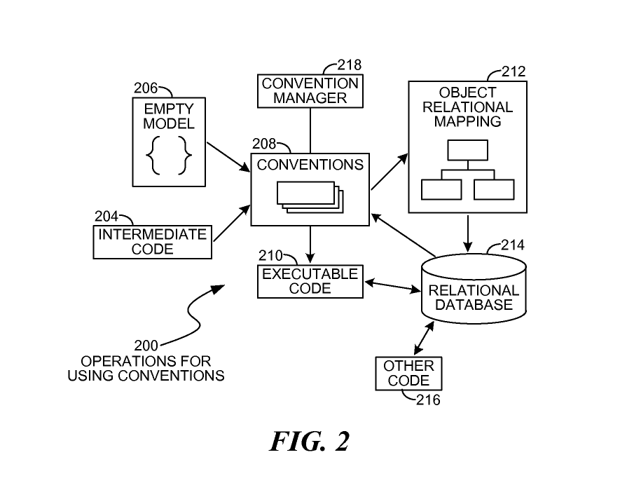

FIG. 2 is a diagram representation of an embodiment 200 illustrating various components and operations performed when an application is created. Embodiment 200 is a conceptual illustration showing a process for creating an application where a data model is inferred from code to create a database, which can be used by the application or another application.

In embodiment 200, a developer may create an application that contains intermediate code 204 and an empty data model 206. At such a stage in development, the application may contain source code or compiled intermediate code but no database or data model.

A set of conventions 208 may be executed against the intermediate code 204 that may infer an object relational mapping 212. The object relational mapping 212 represents a populated version of the entity data model 206 as processed by the conventions 208.

The object relational mapping 212 may be a representation of memory objects that may be used to generate a relational database 214.

After processing the source code or intermediate code with the conventions 208, executable code 210 may be created. The executable code 210 may access the relational database 214. In some embodiments, other code 216 may access the relational database 214.

The conventions 208 may create the object relational mapping 212 according to standardized conventions, which may define a database, including the database name, tables in relational database, the table names, rows in the tables, data types of the database elements, primary and foreign keys in the database, relationships within the database, and other components of the database.

In some embodiments, the object relational mapping 212 may be defined using an XML definition. Some embodiments may be able to display a graphical representation of the object relational mapping 212.

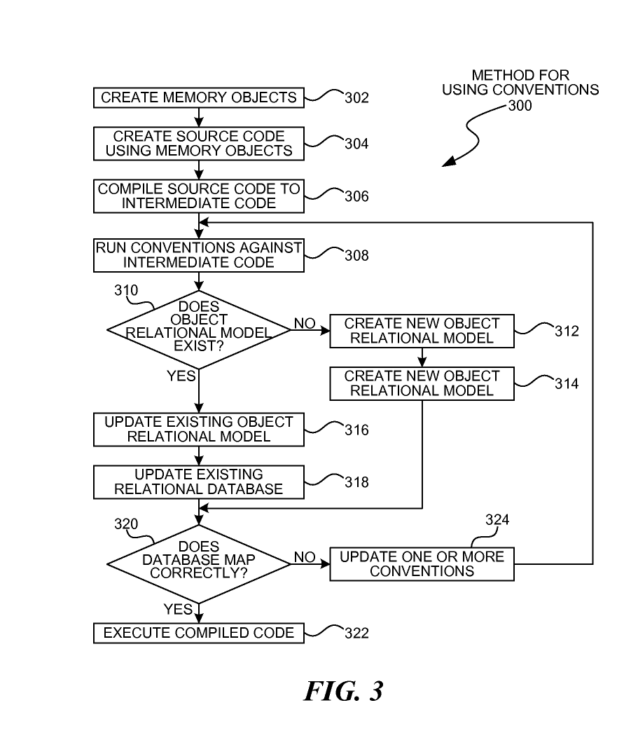

FIG. 3 is a flowchart illustration of an embodiment 300 showing a method for using conventions to generate an object relational model and corresponding database. Embodiment 300 is a simplified example of a method that may be performed by a code development system that generates object relational models from source code.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 300 is a simplified example of a method that may be performed during the development of computer executable code. A set of conventions may be used to analyze the code and infer an object relational model. From the object relational model, a database may be created that may be accessed by the executable code or by another application.

The set of conventions may be changed, updated, added, or deleted to fit a particular developer's style, naming convention, and end goals of the executable code. During the development cycle, the developer may make changes to the set of conventions to cause the conventions to interpret the source code in an intended manner.

In many embodiments, a developer may have a set of conventions that fit the developer's particular style. For example, the developer's naming conventions and style may define a class or other memory object of a specific data type and name. A convention may identify the data type and name as being used as a primary key or foreign key for identifying instances of a particular data object. The convention may then create a corresponding object in the object relational mapping as a key, which may then be implemented in a corresponding database.

In the example, a first developer may use a class named “Key” as a primary key, but a second developer may use a class named “Id”. Each developer may modify an existing convention with their particular preferences, then store the convention with a group of conventions as a version that may be used for a specific application or reused for subsequent applications.

In block 302, a developer may create memory objects and may create source code using the memory objects in block 304. The memory object definitions may be classes, variables, parameters, or other data storage devices within the source code being used to develop an application.

The source code may be compiled into intermediate code in block 306. In some embodiments, the source code may be analyzed by the conventions prior to compilation. In such embodiments, the conventions may analyze the source code directly rather than intermediate code.

Analyzing intermediate code may be useful in embodiments where several different languages may be available in a programming environment. In some cases, analysis of intermediate code may be simpler than analysis of source code, since intermediate code may be optimized and made more consistent than source code.

The conventions may be executed against the intermediate code in block 308. The conventions may analyze the intermediate code to infer various components that can be placed or organized into an object relational model.

If an object relational model does not exist in block 310, a new object relational model may be created in block 312, and a new relational database may be created from the object relational model in block 314.

If an object relational model does exist in block 310, the existing object relational model may be updated in block 316 and an existing relational database may be updated in block 318. In some embodiments, each time the conventions are executed against the intermediate code may result in a new object relational model and new relational database.

In block 320, a developer may analyze the object relational model or the relational database to determine if the mapping is correct. If the mapping is not what the developer anticipated, the developer may update one or more of the conventions in block 324 and the process may return to block 308. In some instances, the developer may update the source code and re-run the process from block 306.

The developer may have control over what the conventions infer from the source code and intermediate code. The developer may be able to add, remove, or modify one or more of the conventions. In some embodiments, the conventions may be arranged in sequence which may affect the priority of how a convention is applied. In such embodiments, the developer may reorder, reprioritize, or otherwise reorganize the conventions.

In some embodiments, one convention may have a dependency on another convention. Such embodiments may have the convention behavior changed by interchanging a dependent convention with another convention, or by redirecting a dependency to another convention. In some embodiments, such a dependency may be expressly defined, while other embodiments may infer or imply a dependency by the sequence the conventions are applied.

When the database maps correctly in block 320, the compiled code may be executed in block 322.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A system comprising:
a first set of data types defining data objects within a programming language for a first application;
a set of conventions that infer a database based on said data objects and said data types, said database being a relational database comprising a plurality of tables and relationships between said tables; and
a relational database system comprising said database, said set of conventions comprising executable code that creates said database as inferred from said data objects and said data types.

2. The system of claim 1, said conventions further inferring an object relational model comprising a relational schema of data stored in said database.

3. The system of claim 2, said object relational model being used by an executable code to interact with data using either said database or said data objects.

4. The system of claim 1, said set of conventions comprising a plurality of conventions comprising a first convention having a dependency on a second convention.

5. The system of claim 4, said dependency being defined by a sequence of said plurality of conventions.

6. The system of claim 4 further comprising a registration system through which a new convention may be added to said set of conventions.

7. The system of claim 6, said registration system that further removes a first convention from said set of conventions.

8. The system of claim 7, said registration system that further changes a first dependency within said set of conventions.

9. The system of claim 1 further comprising a versioning system that defines a first version for a first set of conventions and a second version for a second set of conventions, said versioning system that further can select said first set of conventions or said second set of conventions for executing and application based on a predetermined selection of versions.

10. The system of claim 1 further comprising:
a program execution environment that executes said first application such that a first data object may be accessed by accessing said database.

11. The system of claim 10, said program execution environment that executes said first application such that a portion of data in said database may be accessed by accessing said first data object.

12. A method comprising:
creating a first application source code using a first programming language and comprising data objects defined using data types;
analyzing said first application using a set of conventions and creating a relational database based on said data objects and said data types, said relational database operating on a relational database system;
executing said first application such that said first application may make a call to said relational database to access data contained in a first data object of said data objects.

13. The method of claim 12, said set of conventions defining a primary key identifier, said conventions that search for said primary key identifier within said first application source code to infer a primary key for a table within said relational database.

14. The method of claim 13, said primary key identifier being a property of a first data type.

15. The method of claim 12 further comprising:
compiling said first application source code into executable code.

16. The method of claim 15, said analyzing said first application using said set of conventions being performed on said first application source code.

17. The method of claim 12 further comprising:
compiling said first application source code into intermediate code and said analyzing said first application using a set of conventions being performed on said intermediate code.

18. The method of claim 12 further comprising:
identifying a first convention from said set of conventions;
modifying said first convention to create a second convention; and
replacing said first convention with said second convention within said set of conventions.

19. A system comprising:
a programming interface in which a first set of data types are defined using data objects within a programming language for a first application;
said programming interface comprising a set of conventions that execute against said first application to infer a database based on said data objects and said data types, said database being a relational database comprising a plurality of tables and relationships between said tables; and
a relational database system comprising said database, said set of conventions comprising executable code that creates said database as inferred from said data objects and said data types; and
an executing environment in which said first application may be executed, said first application comprising calls to said database that access data in said data objects.

20. The system of claim 19 further comprising:
a compiler that compiles said first application in said programming language into an executable form executable in said executing environment.
